(19) United States
(12) Patent Application Publication
(10) Pub. No.: US 2004/0136551 A1
(43) Pub. Date: Jul. 15, 2004

(54) Audio apparatus

(75) Inventors: Yasuhisa Abe, Yamagata-ken (JP); Hiroyuki Hamada, Saitama-ken (JP); Shintaro Hosoi, Saitama-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignees: Pioneer Corporation; Tohoku Pioneer Corporation

(21) Appl. No.: 10/742,774

(22) Filed: Dec. 23, 2003

(30) Foreign Application Priority Data
Jan. 8, 2003 (JP) 2003-002395

(51) Int. Cl. H04R 5/02; H04B 1/00

(52) U.S. Cl. 381/302; 381/86; 381/389

(57) ABSTRACT

An audio apparatus includes a main audio signal processing circuit (12) for processing an audio signal read from a sound source (10), and a set of main speakers (SPA) and at least one set of sound effect speakers (SPB, SPC, etc.) which receive inputs of the audio signal undergoing the signal processing by the signal processing circuit (12). The main speaker (SPA) is mounted on an A-pillar (AP) in a vehicle passenger space, for example. The sound effect speakers (SPB, SPC, etc.) are mounted in a lower portion of the console (C), for example.

### BACKGROUND OF THE INVENTION

1. Field of the Invention

This invention relates to an audio apparatus having an acoustic effect-producing function.

The present application claims priority from Japanese Application No. 2003-2395, the disclosure of which is incorporated herein by reference.

2. Description of the Related Art

Some conventionally known audio apparatuses have the acoustic effect-producing function of generating the pseudo-sound of a reverberant sound and the like originally created in a concert hall from a music source such as a CD so as to produce, in a room at home or the like, a sound field similar to the original sound field in the concert hall, when the music is reproduced.

FIG. 1 is a schematic block diagram illustrating the structure of a conventional audio apparatus having such an acoustic effect-producing function, in which an amplifier is omitted. The conventional audio apparatus mixes a source sound signal which is read out from a sound source 1 such as a CD or a music record, and a pseudo-acoustic sound (reverberation component-generating sound) signal b generated by means of the extraction of a reverberation component from the source sound signal a for signal processing in an audio signal processing circuit 2, and then outputs the mixture to a speaker SP.

Then the pseudo-acoustic sound together with the sound from the sound source (hereinafter referred to as “source sound”) is outputted from the speaker SP in order to produce, in a sound-reproduction space SF, a sound field including reverberant sound and the like resembling the original sound field created in the concert hall.

However, in the structure of the conventional audio apparatus as described above, the source sound and the pseudo-acoustic sound are both outputted into the single sound-reproduction space SF. Hence, the pseudo-acoustic sound is also affected by the so-called “acoustics” of the sound-reproduction space SF. As a result, the relation between the source sound and the pseudo-acoustic sound is repeated in each small portion of the indirect sound component in the sound-reproduction space SF.

The interrelationship between the acoustic sound and the direct sound in the concert hall or the like is originally weak, but the conventional audio apparatus is under great influence from the characteristics of the sound-reproduction space, and therefore the interrelationship between the source sound and the pseudo-acoustic sound is increased. Hence the conventional audio apparatus has the problem of making it difficult for a listener(s) to perceive the acoustic sound in itself, and the like.

Further, when the conventional audio apparatus as described above is placed in a narrow space (e.g. the vehicle passenger space) for sound reproduction, this produces the problem of the impossibility of satisfying all the requirements for sound relating to the balance in tone quality, the localization, and the perception of the sound field.

FIG. 2A shows the impulse response measured when a speaker of the conventional audio apparatus is mounted on an A-pillar in the vehicle passenger space. FIG. 2B shows the sound-pressure frequency characteristics obtained from analysis of the impulse response in FIG. 2A for a duration of 70 ms after it commences.

In FIG. 2A, the impulse response shows a high-level waveform with the passage of time because of degeneracy resulting from the sound reflection. In FIG. 2B, peaks and dips significantly occur in a range from a midpoint of a band toward the right. It can be understood from the characteristics as described in FIGS. 2A and 2B that some of the conventional audio apparatuses have the problem of being incapable of providing smooth sound.

FIG. 3A shows the impulse response measured when a speaker of the conventional audio apparatus is placed in a lower portion of the console in the vehicle passenger space. FIG. 3B shows the sound-pressure frequency characteristics obtained from the analysis of the impulse response in FIG. 3A for a duration of 70 ms after it commences.

The spikes in the waveform of an impulse response shown in FIG. 3A are fewer than those shown in FIG. 2A, and the characteristic undulations are fewer in FIG. 3B. However, the waveform in the rising portion of the impulse response in FIG. 3A, namely, the waveform of the direct sound, is weaker than that of the other portions subsequent to that. From this fact, it can be understood that some of the conventional audio apparatuses have the problem of lack of stereo sound and ambience because of unclear sound localization.

### SUMMARY OF THE INVENTION

The present invention is primarily intended to solve the problems associated with the conventional audio apparatuses as described above.

Therefore it is an object of the present invention to provide an audio apparatus capable of lessening the characteristics in conventional audio apparatuses of lacking stereo sound and ambience because of the unclear sound localization, and achieving a balance in tone quality, more precise localization of sound, more spatial sound-field perception, and the like.

To attain this object, the present invention provides an audio apparatus having the feature of including; a signal processing circuit for processing an audio signal read from a sound source; and a set of main speakers and at least one set of sound effect speakers independently mounted in different positions from each other in a vehicle passenger space and receiving the audio signal undergoing the signal processing by the signal processing circuit.

As regards the audio apparatus according to the present invention, the sound effect speaker installed in a predetermined position inside a vehicle passenger space has the characteristics of creating less spikes in an impulse response, of having less characteristic undulations in the frequency characteristic, and of being less receptive to the sound-field characteristic of a vehicle passenger space. The main speaker installed in a position different from that of the sound effect speaker in the vehicle passenger space has characteristics of showing a high-level waveform in an impulse response with the passage of time because of degeneracy resulting from sound reflection to provide unsmooth sound. Thus the characteristics of the effect sound speaker lessen the characteristics of the main speaker. Further the main speaker lessens the characteristics in the sound effect speaker of lacking stereo sound and ambience because of unclear sound localization caused by the fact that the waveform in the rising portion of the impulse response resulting at output from the sound effect speaker, namely, the waveform of the direct sound, is weaker than that of the other portions subsequent to that. This makes it possible to adequately provide an effect relating to all the factors such as the balance in tone quality, the sound localization, the perception of the sound field, and the like.

These and other objects and features of the present invention will become more apparent from the following detailed description with reference to the accompanying drawings.

### BRIEF DESCRIPTION OF THE DRAWINGS

FIG. 1 is a block diagram illustrating a conventional audio apparatus.

FIG. 2A is a graph showing the impulse response resulting from the output from a speaker of a conventional audio apparatus mounted on an A-pillar of a vehicle.

FIG. 2B is a graph showing the sound pressure frequency characteristics of the speaker in FIG. 2A.

FIG. 3A is a graph showing the impulse response resulting from the output from a speaker of a conventional audio apparatus mounted on a lower portion of the console of a vehicle.

FIG. 3B is a graph showing the sound pressure frequency characteristics of the speaker in FIG. 3A.

FIG. 4 is a-block diagram illustrating the structure of an audio apparatus according to the present invention.

FIG. 5 is a diagram illustrating the placement of a main speaker and a sound effect speaker of the audio apparatus.

FIG. 6A is a graph showing the impulse response resulting from the output from the main speaker of the audio apparatus.

FIG. 6B is a graph showing the impulse response resulting from the output from the sound effect speaker of the audio apparatus.

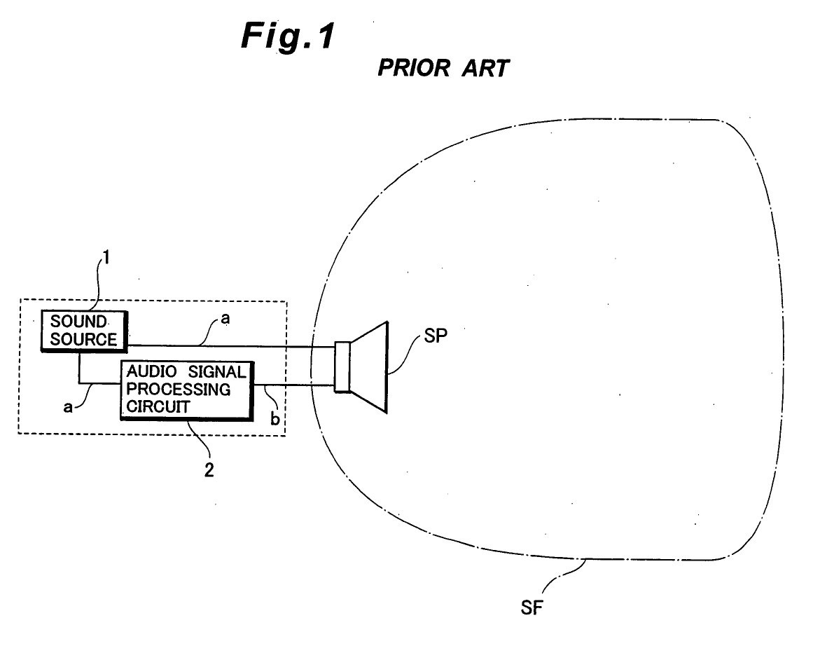

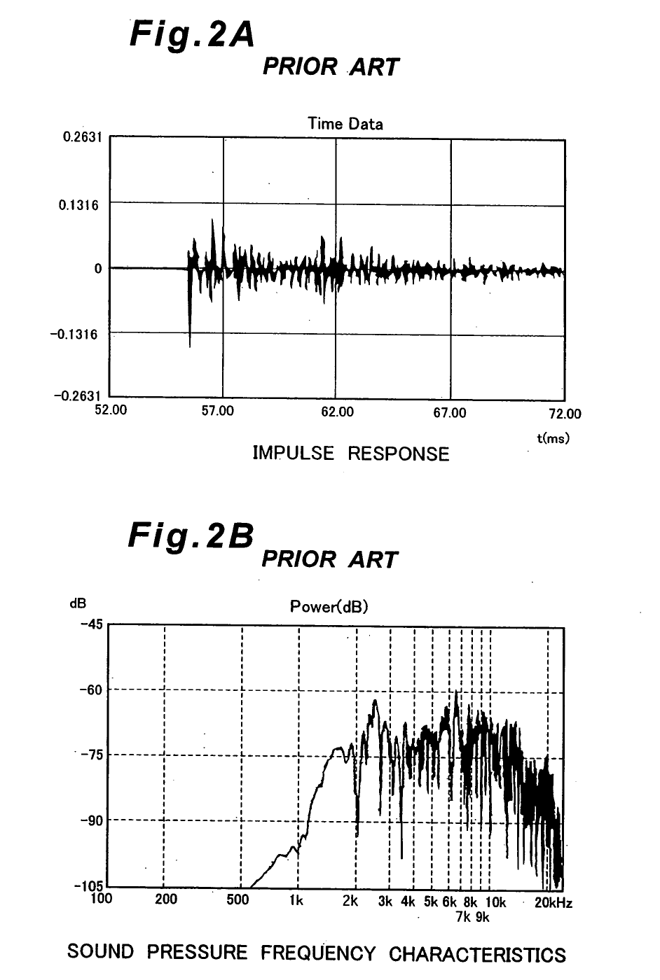

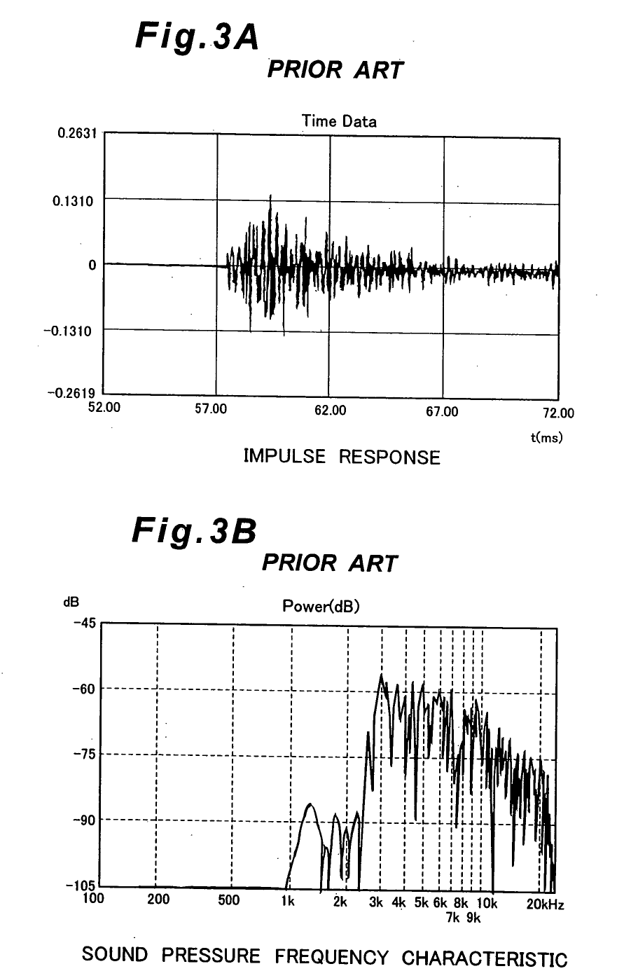

### DETAILED DESCRIPTION OF THE PREFERRED EMBODIMENT

A preferred embodiment according to the present invention will be described below in detail with reference to the accompanying drawings.

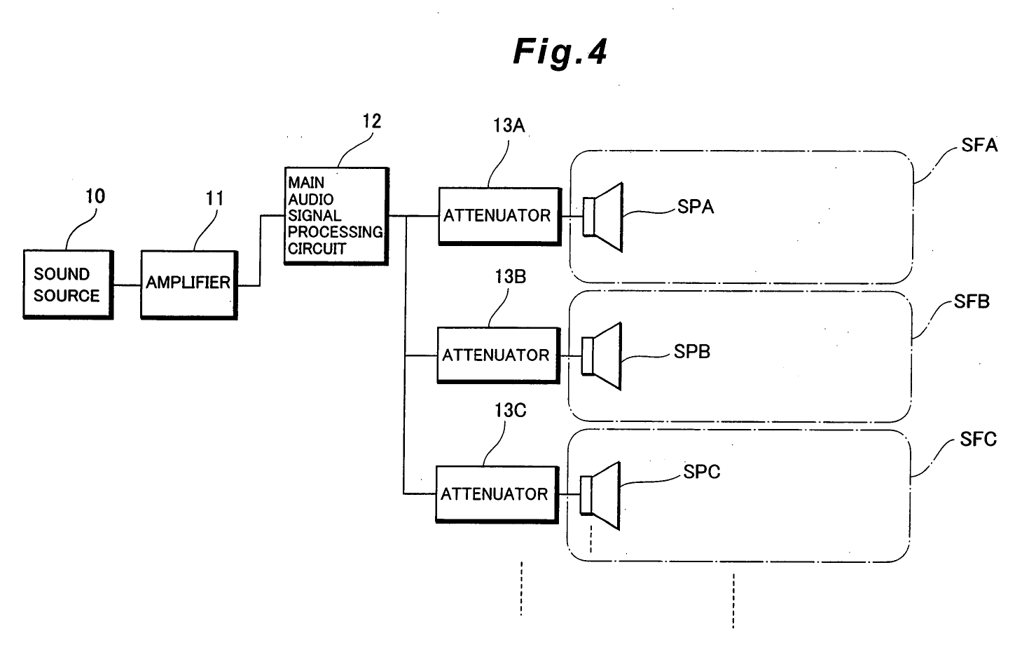

FIG. 4 is a block diagram illustrating a first embodiment of an audio apparatus according to the present invention.

The audio apparatus illustrated in FIG. 4 includes: a main speaker SPA mainly for reproducing the source sound; a given number of sound effect speakers (speakers for creating sound effects) SPB, SPC, etc. for reproducing sound effects; an amplifier 11 for amplifying an audio signal read from a sound source 10; and an audio signal processing circuit 12 for processing the audio signal amplified by the amplifier 11 for reproduction of the source sound.

The audio apparatus has an attenuator 13A provided between and connected to the main audio signal processing circuit 12 and the main speaker SPA. Likewise, attenuators 13B, 13C, etc. are respectively provided between and connected to the main audio signal processing circuit 12 and sound effect speakers SPB, SPC, etc.

In the structure of the audio apparatus illustrated in FIG. 4, the order of connection of the amplifier 11 and the main audio signal processing circuit 12 may be reversed. The connection of attenuators 13A, 13B, 13C, etc. is not be necessarily required.

The audio apparatus reads an audio signal from the sound source 10 such as a CD, then amplifies the audio signal in the amplifier 11, and then inputs the amplified audio signal to the main audio signal processing circuit 12 to perform the signal processing required for faithfully reproducing the sound source from the audio signal.

Then, the audio apparatus inputs the audio signal, undergoing signal processing by the main audio signal processing circuit 12, via the attenuator 13A to the main speaker SPA, and then outputs the source sound from the main speaker SPA into a sound-reproduction space SFA served by the main speaker SPA.

Meanwhile, the audio signal undergoing signal processing by the main audio signal processing circuit 12 is inputted via the attenuators 13B, 13C, etc. to the corresponding sound effect speakers SPB, SPC, etc. Then, the audio signals are individually outputted from the sound effect speakers SPB, SPC, etc. into the sound-reproduction spaces SFB, SFC, etc. respectively served by the sound effect speakers SPB, SPC, etc.

Regarding the placement of the main speaker SPA and the sound effect speakers SPB, SPC, etc. of the audio apparatus in the vehicle passenger space, the main speaker SPA is mounted on an A-pillar and the sound effect speakers SPB, SPC, etc. are mounted in a lower portion of the console. The speakers SPA, SPB, SPC, etc. are positioned such that the distance between the main speaker SPA and a listening point in the vehicle passenger space is 50 cm to 70 cm shorter than the distance between the sound effect speakers SPB, SPC, etc. and the listening point.

If the attenuators 13A, 13B, 13C, etc. are provided, the output sensitivity level of each of the sound effect speakers SPB, SPC, etc. is set at 7.7 dB higher than that of the main speaker SPA.

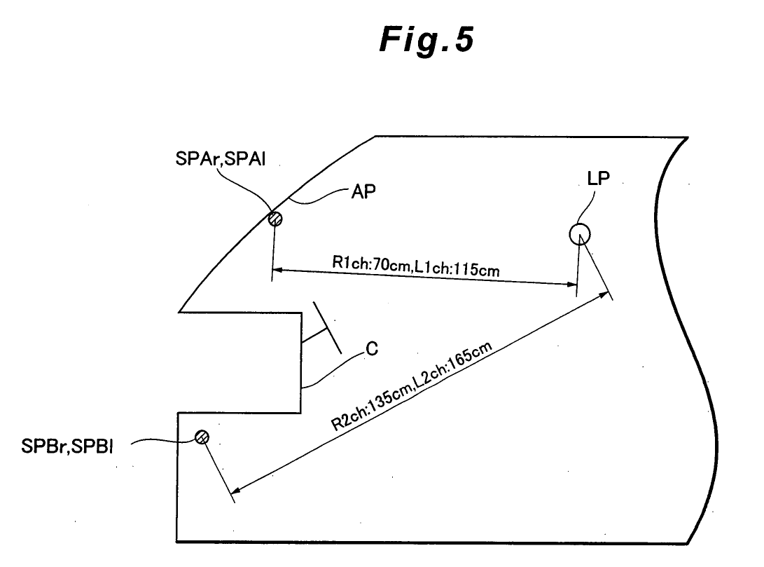

FIG. 5 is a speaker layout diagram illustrating an example of the mounting positions of the main speaker SPA and sound effect speakers SPB of the audio apparatus inside the vehicle passenger space.

In FIG. 5, the right-hand main speaker SPAr is mounted in a position on the right-hand A-pillar AP such that a distance R1ch between itself and the listening point (the head of the driver sitting in the driver's seat in FIG. 5) LP is about 70 cm. Likewise, the left-hand main speaker SPA1 is mounted in a position on the left-hand A-pillar AP at a distance L1ch of about 115 cm from the listening point LP.

The right-hand sound effect speaker SPBr is mounted in a position in the lower right-hand portion of the console C at a distance R2ch of about 135 cm from the listening point LP. The left-hand sound effect speaker SPB1 is mounted in a position in the lower left-hand portion of the console C at a distance L2ch of about 165 cm from the listening point LP.

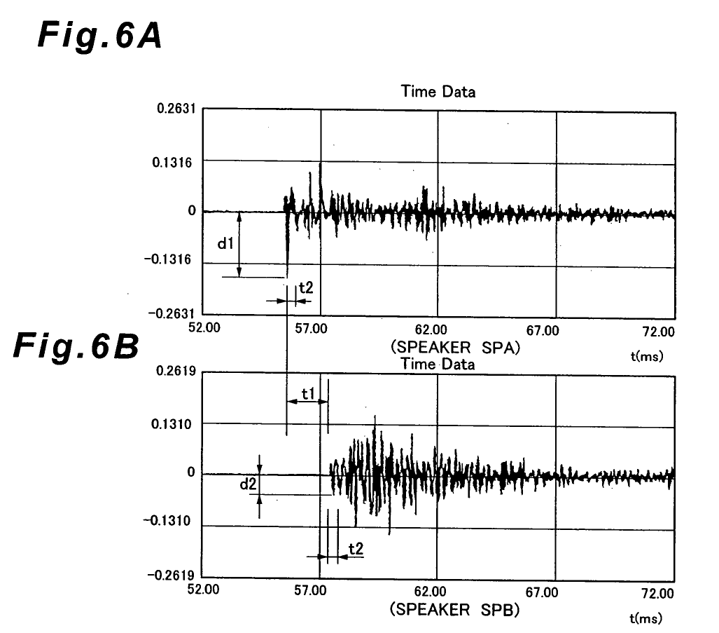

FIGS. 6A and 6B are graphs showing examples of the impulse responses from the main speaker SPA and the sound effect speaker SPB placed in the foregoing positions. FIG. 6A shows the impulse response from the main speaker SPA reproducing the source sound from an audio signal undergoing signal processing by the main audio signal processing circuit 12. FIG. 6B shows the impulse response from the sound effect speakers SPB, SPC, etc.

Comparing FIG. 6A and FIG. 6B, the sound effect outputted from the sound effect speaker SPB reaches the listening point LP (see FIG. 5) with a time delay of interval t1 (2 ms in FIG. 6B) from the arrival time of the source sound outputted from the main speaker SPA.

The difference (d1−d2) between a time waveform d1 (dB) within a predetermined time interval t2 (0.4 ms in FIG. 6A) from the rising time of the source sound from the main speaker SPA as measured at the listening point LP, and the time waveform d2 (dB) within a predetermined time interval t2 (0.4 ms in FIG. 6B) from the rising time of the sound effect outputted from each of the sound effect speakers SPB, SPC, etc. as measured at the listening point LP is equal to or higher than the predetermined value (e.g. 10 dB).

When the attenuators 13A, 13B, 13C, etc. (see FIG. 4) are provided, a difference 7.7 dB in the output sensitivity level between the sound effect speakers SPB, SPC, etc. and the main speaker SPA is the sensitivity level required as the speaker outputs of the main speaker SPA and sound effect speakers SPB, SPC, etc. in order for the difference (d1−d2) at the listening point LP to be observed.

This is the value before undergoing the effect of the characteristics created by the vehicle passenger space. When the difference is actually observed at the listening point LP, in some instances the vehicle-space characteristic may be further taken into account and the difference 7.7 dB of the output sensitivity level may be changed.

The mounting position of the main speaker SPA is not limited to the A-pillar. The main speaker SPA may be mounted under the dashboard or on the front door (the inner side of the door mirror), for example.

Also the mounting position of the sound effect speakers SPB, SPC, etc. is not limited to the lower portion of the console. The sound effect speakers SPB, SPC, etc. may be mounted under the console, on a lower portion of a front seat or on the kick panel, for example.

As described hitherto, with the foregoing audio apparatus, each of the sound effect speakers SPB, SPC, etc. mounted in predetermined positions (e.g. a lower portion of the console C) inside the vehicle passenger space has the characteristics of creating less spikes in an impulse response, of having less characteristic undulations in the frequency characteristic, and of being less receptive to the sound-field characteristic of a vehicle passenger space. The main speaker SPA mounted in a position (e.g. A-pillar AP) different from that of the sound effect speaker in the vehicle passenger space has the characteristics of showing a high-level waveform in an impulse response with the passage of time because of degeneracy resulting from sound reflection to provide unsmooth sound. Thus the characteristics of the effect sound speaker lessen the characteristics of the main speaker. Further the main speaker SPA lessens the characteristics in the sound effect speaker SPB, SPC, etc. of lacking stereo sound and ambience because of unclear sound localization caused by the fact that the waveform in the rising portion of the impulse response resulting from the output from the sound effect speaker, namely, the waveform of the direct sound, is weaker than that of the other portions subsequent to that.

The placement of the main speaker SPA and the sound effect speakers SPB, SPC, etc. with respect to the listening point LP is determined in the foregoing manner. The source sound undergoing signal processing in the main speaker audio signal processing circuit 12 is outputted from the main speaker SPA toward the inside of the sound-reproduction space SFA (see FIG. 4) served by the main speaker SPA, and also being outputted from the individual sound effect speakers SPB, SPC, etc. toward the insides of the respective sound-reproduction spaces SFB, SFC, etc. Hence, as compared with conventional audio apparatuses outputting both source sound and sound effects (pseudo-acoustic sound) into a single sound-reproduction space, the audio apparatus according to the present invention has a lower degree of interrelationship between the source sound and the sound effects. This makes it possible to provide an adequate effect relating to all the factors such as the balance in tone quality, the localization, the perception of sound field, and the like.

A generic concept of the audio apparatus described in the embodiment is embodied in an audio apparatus including; a signal processing circuit for processing an audio signal read from a sound source; and a set of main speakers and at least one set of sound effect speakers independently mounted in different positions from each other in a vehicle passenger space and receiving the audio signal undergoing the signal processing by the signal processing circuit.

As regards the audio apparatus in the generic concept, the sound effect speaker installed in the predetermined position inside a vehicle passenger space has the characteristics of creating less spikes in an impulse response, of having less characteristic undulation in the frequency characteristic, and of being less receptive to the sound-field characteristic of a vehicle passenger space. The main speaker installed in a position different from that of the sound effect speaker in the vehicle passenger space has the characteristics of showing a high-level waveform in an impulse response with the passage of time because of degeneracy resulting from sound reflection to provide unsmooth sound. Thus the characteristics of the effect sound speaker lessen the characteristics of the main speaker. Further the main speaker lessens the characteristics in the sound effect speaker of lacking stereo sound and ambience because of unclear sound localization caused by the fact that the waveform in the rising portion of the impulse response resulting at output from the sound effect speaker, namely, the waveform of the direct sound, is weaker than that of the other portions subsequent to that. This makes it possible to provide an adequate effect relating to all the factors of the balance in tone quality, the sound localization, the perception of the sound field, and the like.

The terms and description used herein are set forth by way of illustration only and are not meant as limitations. Those skilled in the art will recognize that numerous variations are possible within the spirit and scope of the invention as defined in the following claims.

What is claimed is:

1. An audio apparatus comprising:
a signal processing circuit for processing an audio signal read from a sound source; and
a set of main speakers and at least one set of sound effect speakers independently mounted in different positions from each other in a vehicle passenger space and receiving the audio signal undergoing the signal processing by the signal processing circuit.

2. An audio apparatus according to claim 1, wherein the main speaker is mounted on an A-pillar inside the vehicle passenger space, and the sound effect speaker is mounted under a console.

3. An audio apparatus according to claim 1, wherein the main speaker and the sound effect speaker are placed in respective positions of allowing a distance between the sound effect speaker and a listening position predetermined inside the vehicle passenger space to be longer by a predetermined value than a distance between the main speaker and the listening position.

4. An audio apparatus according to claim 3, wherein the predetermined value ranges from 50 cm to 70 cm.

5. An audio apparatus according to claim 3, wherein the distance between a right-hand speaker of the main speaker and the listening position is set as 70 cm, the distance between a left-hand speaker of the main speaker and the listening position is set as 115 cm, the distance between a right-hand speaker of the sound effect speaker and the listening position is set as 135 cm, and the distance between a left-hand speaker of the sound effect speaker and the listening position is set as 165 cm.

6. An audio apparatus according to claim 1, wherein an output sensitivity level of the sound effect speaker is set higher than an output sensitivity level of the main speaker by a predetermined value.

7. An audio apparatus according to claim 6, wherein the predetermined value is 7.7 dB.
